(19) United States
(12) Patent Application Publication
(10) Pub. No.: US 2022/0109610 A1
(43) Pub. Date: Apr. 7, 2022

(54) METHODS, SYSTEMS, ARTICLES OF MANUFACTURE AND APPARATUS TO ORCHESTRATE INTERMITTENT SURPLUS POWER IN EDGE NETWORKS

(71) Applicant: Intel Corporation, Santa Clara, CA (US)

(72) Inventors: Francesc Guim Bernat, Barcelona (ES); Karthik Kumar, Chandler, AZ (US); Marcos Carranza, Portland, OR (US); Cesar Martinez-Spessot, Hillsboro, OR (US); Han Lee, Sammamish, WA (US)

(21) Appl. No.: 17/555,109

(22) Filed: Dec. 17, 2021

(51) Int. Cl. H04L 41/0896; H04L 41/5022; H04L 41/5006; H04L 41/12

(52) U.S. Cl. CPC H04L 41/0896; H04L 41/12; H04L 41/5006; H04L 41/5022

(57) ABSTRACT

Methods, apparatus, systems, and articles of manufacture are disclosed to orchestrate intermittent surplus power in Edge networks. An example apparatus includes power unit analysis circuitry to identify a power surplus, analysis circuitry to (a) apply an acceleration factor to a first trigger threshold of a local task, the acceleration factor to set a second trigger threshold, and (b) designate the local task for early execution when a current metric corresponding to the local task satisfies the second trigger threshold, and adaptive power managing circuitry to execute the local task in response to detecting the designation for early execution.

### FIELD OF THE DISCLOSURE

This disclosure relates generally to edge networks and, more particularly, to methods, systems, articles of manufacture and apparatus to orchestrate intermittent surplus power in edge networks.

### BACKGROUND

In recent years, renewable energy sources have been used to provide power to network nodes. In some examples, network nodes are located in very remote areas that are not proximate to traditional power supplies, transmission lines and/or other power sources. Renewable energy sources include arrays of solar cells, wind turbines, and others.

### BRIEF DESCRIPTION OF THE DRAWINGS

FIG. A1 illustrates an overview of an Edge cloud configuration for Edge computing.

FIG. A2 illustrates operational layers among endpoints, an Edge cloud, and cloud computing environments.

FIG. A3 illustrates an example approach for networking and services in an Edge computing system.

FIG. 1 is a schematic illustration of an example task management system to orchestrate intermittent surplus power in Edge networks.

FIGS. 2-4 are flowcharts representative of example machine readable instructions and/or example operations that may be executed by example processor circuitry to implement the adaptive power managing circuitry of FIG. 1.

FIG. 5 is a block diagram of an example processing platform including processor circuitry structured to execute the example machine readable instructions and/or the example operations of FIGS. 2-4 to implement the example adaptive power managing circuitry of FIG. 1.

FIG. 6 is a block diagram of an example implementation of the processor circuitry of FIG. 5.

FIG. 7 is a block diagram of another example implementation of the processor circuitry of FIG. 5.

FIG. 8 is a block diagram of an example software distribution platform (e.g., one or more servers) to distribute software (e.g., software corresponding to the example machine readable instructions of FIGS. 2-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

FIG. A1 is a block diagram A100 showing an overview of a configuration for Edge computing, which includes a layer of processing referred to in many of the following examples as an “Edge cloud.” As shown, the Edge cloud A110 is co-located at an Edge location, such as an access point or base station A140, a local processing hub A150, or a central office A120, and thus may include multiple entities, devices, and equipment instances. The Edge cloud A110 is located much closer to the endpoint (consumer and producer) data sources A160 (e.g., autonomous vehicles A161, user equipment A162, business and industrial equipment A163, video capture devices A164, drones A165, smart cities and building devices A166, sensors and IoT devices A167, etc.) than the cloud data center A130. Compute, memory, and storage resources, which are offered at the edges in the Edge cloud A110, are critical to providing ultra-low latency response times for services and functions used by the endpoint data sources A160 as well as reducing network backhaul traffic from the Edge cloud A110 toward cloud data center A130, thereby improving energy consumption and overall network usages among other benefits.

Compute, memory, and storage are scarce resources and generally decrease depending on the Edge location (e.g., fewer processing resources being available at consumer endpoint devices, than at a base station, than at a central office). However, the closer the Edge location is to the endpoint (e.g., user equipment (UE)), the more space and power becomes constrained. Thus, Edge computing attempts to reduce the amount of resources needed for network services, through the distribution of more resources that are located closer both geographically and in network access time. In this manner, Edge computing attempts to bring the compute resources to workload data where appropriate, or bring the workload data to the compute resources. In some examples, a workload includes, but is not limited to executable processes, such as algorithms, machine learning algorithms, image recognition algorithms, gain/loss algorithms, etc.

The following describes aspects of an Edge cloud architecture that covers multiple potential deployments and addresses restrictions that some network operators or service providers may have in their own infrastructures. These include configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge,” “close Edge,” “local Edge,” “middle Edge,” or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices that are much closer to endpoint devices producing and consuming the data. For example, Edge gateway servers may be equipped with pools of memory and storage resources to perform computation in real-time for low latency use-cases (e.g., autonomous driving or video surveillance) for connected client devices. In another example, base stations may be augmented with compute and acceleration resources to directly process service workloads for connected user equipment, without further communicating data via backhaul networks. In yet another example, central office network management hardware may be replaced with standardized compute hardware that performs virtualized network functions and offers compute resources for the execution of services and consumer functions for connected devices. Within Edge computing networks, there may be scenarios in services which the compute resource is “moved” to the data, as well as scenarios in which the data is “moved” to the compute resource. In another example, base station compute, acceleration and network resources can provide services to scale to workload demands on an as-needed basis by activating dormant capacity (subscription, capacity on demand) to manage corner cases, emergencies or to provide longevity for deployed resources over a significantly longer implemented lifecycle.

FIG. A2 illustrates operational layers among endpoints, an Edge cloud, and cloud computing environments. Specifically, FIG. A2 depicts examples of computational use cases A205 utilizing the Edge cloud A110 among multiple illustrative layers of network computing. The layers begin at an endpoint (devices and things) layer A200, which accesses the Edge cloud A110 to conduct data creation, analysis, and data consumption activities. The Edge cloud A110 may span multiple network layers such as an Edge devices layer A210 having gateways, on-premise servers, or network equipment (nodes A215) located in physically proximate Edge systems; a network access layer A220, encompassing base stations, radio processing units, network hubs, regional data centers (DC), or local network equipment (equipment A225); and any equipment, devices, or nodes located therebetween (in layer A212, not illustrated in detail). The network communications within the Edge cloud A110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer A200, under 5 ms at the Edge devices layer A210, to between 10 to 40 ms when communicating with nodes at the network access layer A220. Beyond the Edge cloud A110 are core network A230 and cloud data center A240 layers, each with increasing latency (e.g., between 50-60 ms at the core network layer A230, to 100 ms or more at the cloud data center layer). As a result, operations at a core network data center A235 or a cloud data center A245, with latencies of at least 50 to 100 ms or more, will not be able to accomplish many time-critical functions of the use cases A205. Each of these latency values is provided for purposes of illustration and contrast; the use of other access network mediums and technologies may further reduce the latencies. In some examples, respective portions of the network may be categorized as “close Edge,” “local Edge,” “near Edge,” “middle Edge,” or “far Edge” layers, relative to a network source and destination. For instance, from the perspective of the core network data center A235 or a cloud data center A245, a central office or content data network may be considered as being located within a “near Edge” layer (“near” to the cloud, having high latency values when communicating with the devices and endpoints of the use cases A205), whereas an access point, base station, on-premise server, or network gateway may be considered as located within a “far Edge” layer (“far” from the cloud, having low latency values when communicating with the devices and endpoints of the use cases A205). Other categorizations of a particular network layer as constituting a “close,” “local,” “near,” “middle,” or “far” Edge may be based on latency, distance, number of network hops, or other measurable characteristics, as measured from a source in any of the network layers A200-A240.

The various use cases A205 may access resources under usage pressure from incoming streams due to multiple services utilizing the Edge cloud. To achieve results with low latency, the services executed within the Edge cloud A110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the terms described may be managed at each layer in a way to assure real-time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate. In some examples, an SLA is an agreement, commitment and/or contract between entities. The SLA may include parameters (e.g., latency) and corresponding values (e.g., time in milliseconds) that must be satisfied before the SLA is deemed compliant.

Thus, with these variations and service features in mind, Edge computing within the Edge cloud A110 may provide the ability to serve and respond to multiple applications of the use cases A205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, the advantages of Edge computing come with caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust functions are also required because Edge locations may be unmanned and may even need permissioned access (e.g., when housed in a third-party location). Such issues are magnified in the Edge cloud A110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud A110 (network layers A200-A240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco,” or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems that include discrete or connected hardware or software configurations to facilitate or use the Edge cloud A110.

As such, the Edge cloud A110 is formed from network components and functional features operated by and within Edge gateway nodes, Edge aggregation nodes or other Edge compute nodes among network layers A210-A230. The Edge cloud A110 may be embodied as any type of network that provides Edge computing and/or storage resources that are proximately located to radio access network (RAN) capable endpoint devices (e.g., mobile computing devices, IoT devices, smart devices, etc.), which are discussed herein. In other words, the Edge cloud A110 may be envisioned as an “Edge” that connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

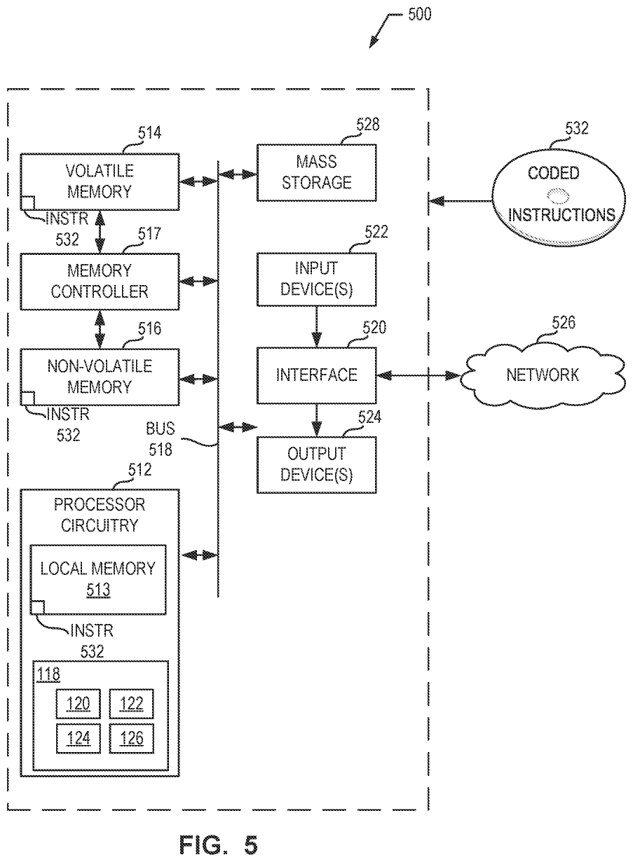

The network components of the Edge cloud A110 may be servers, multi-tenant servers, appliance computing devices, and/or any other type of computing devices. For example, the Edge cloud A110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, which may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, Edge devices are presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 5-7, described in further detail below. The Edge cloud A110 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

In FIG. A3, various client endpoints A310 (in the form of mobile devices, computers, autonomous vehicles, business computing equipment, industrial processing equipment) exchange requests and responses that are specific to the type of endpoint network aggregation. For instance, client endpoints A310 may obtain network access via a wired broadband network by exchanging requests and responses A322 through an on-premise network system A332. Some client endpoints A310, such as mobile computing devices, may obtain network access via a wireless broadband network by exchanging requests and responses A324 through an access point (e.g., cellular network tower) A334. Some client endpoints A310, such as autonomous vehicles, may obtain network access for requests and responses A326 via a wireless vehicular network through a street-located network system A336. However, regardless of the type of network access, the TSP may deploy aggregation points A342, A344 within the Edge cloud A110 to aggregate traffic and requests. Thus, within the Edge cloud A110, the TSP may deploy various compute and storage resources, such as at Edge aggregation nodes A340, to provide requested content. The Edge aggregation nodes A340 and other systems of the Edge cloud A110 are connected to a cloud or data center A360, which uses a backhaul network A350 to fulfill higher-latency requests from a cloud/data center for websites, applications, database servers, etc. Additional or consolidated instances of the Edge aggregation nodes A340 and the aggregation points A342, A344, including those deployed on a single server framework, may also be present within the Edge cloud A110 or other areas of the TSP infrastructure.

Edge nodes operate in many different types of environments. Edge node environments disclosed herein focus on circumstances where the Edge nodes obtain power from renewable resources that are not connected to typical power sources (e.g., a power grid infrastructure that supplies 120 VAC, 240 VAC, etc. from coal-fired, oil-fired, nuclear power, etc.). Edge nodes disclosed herein include at least one battery as well as connectivity to a renewable power source, such as wind (e.g., wind turbines) and/or solar. Generally speaking, renewable power sources are sometimes referred to herein as ambient power sources. The availability of power output by these sources can vary in a manner difficult to predict. For instance, while expected durations of daylight are reliably predicted when utilizing solar power, cloud cover and weather reduce solar power output capabilities in a much less predictable manner. Similarly, while wind power is not necessarily affected by sundown events, wind can be intermittently available.

Edge nodes that utilize renewable power sources charge on-board power reserves (e.g., one or more batteries) when power output from those renewable power sources is available, thereby allowing the Edge nodes to operate during circumstances where there is no sunlight (e.g., evening/night), where sunlight is occluded (e.g., storms, clouds), and/or where there is no wind. Examples disclosed herein virtualize and/or otherwise normalize power in terms of “units” as a currency for prioritizing selection of particular Edge nodes capable of accepting workload tasks from other Edge nodes. Because different Edge nodes can be heterogeneous (e.g., different on-board resources, different battery capacities, etc.), examples herein normalize node battery capacities in “power units” that are relevant to relative capabilities of co-participating nodes. Tasks/workloads performed by the various nodes in an Edge network are rated on a relative basis using “power units” that consider, in part, (a) task transactions and (b) corresponding computing cycles per transaction (specific to each node). For instance, a first example task on a first example node (e.g., a computing platform) may require a different number of computing cycles per transaction depending on a number of processors the node has, a number of cores per processor the node has, and/or the types of processing resources the node can invoke to execute the transactions (e.g., a CPU, a GPU, a DSP, etc.).

Examples disclosed herein evaluate candidate proactive task execution in view of circumstances of excess ambient power. For instance, Edge node tasks related to garbage collection or persistent memory defragmentation may have established thresholds to trigger task execution. To illustrate, a normal trigger threshold is 70% to trigger defragmentation (as a low priority process) and 90% to trigger defragmentation (as a high/urgent priority process). However, examples disclosed herein consider improved utilization of excess ambient power that cannot be stored when an on-board battery is already at 100% charge capacity. If the excess ambient power is not consumed, it is wasted. As such, examples disclosed herein apply an acceleration factor (offset) to established threshold values in response to surplus ambient power to accelerate triggering of tasks that would not otherwise occur, thereby utilizing the surplus ambient power in a productive manner. Continuing with the aforementioned example, if a current defragmentation value is only 35% (which is substantially below a threshold at which fragmentation is triggered for a low priority process), examples disclosed herein cause the defragmentation process to begin to bring the defragmentation value down to 0%, which buffers additional time for future tasks to be executed and reduces reliance upon consuming battery power in the future for that particular task. Additionally, this example scenario permits more battery power to be reserved for future planned tasks and future emergency tasks.

While the aforementioned example related to defragmentation acceleration assists proactive power management for one node, examples disclosed herein also broadcast their power surplus to other nodes to enable proactive task offloading from one node to another. For instance, a surplus node may broadcast and/or otherwise advertise a power surplus to any number of communicatively connected Edge nodes, some of which have tasks suitable for offloading to another node. Such offloaded tasks are analyzed to determine a number of power units required to satisfy those tasks, and such surplus nodes (e.g., donor nodes) are analyzed to determine a number of surplus power units available for consumption. Stated differently, examples disclosed herein enable computation offloading as a service to other Edge appliances that may have a deficit of power units and/or heavy task requirement, as disclosed in further detail below.

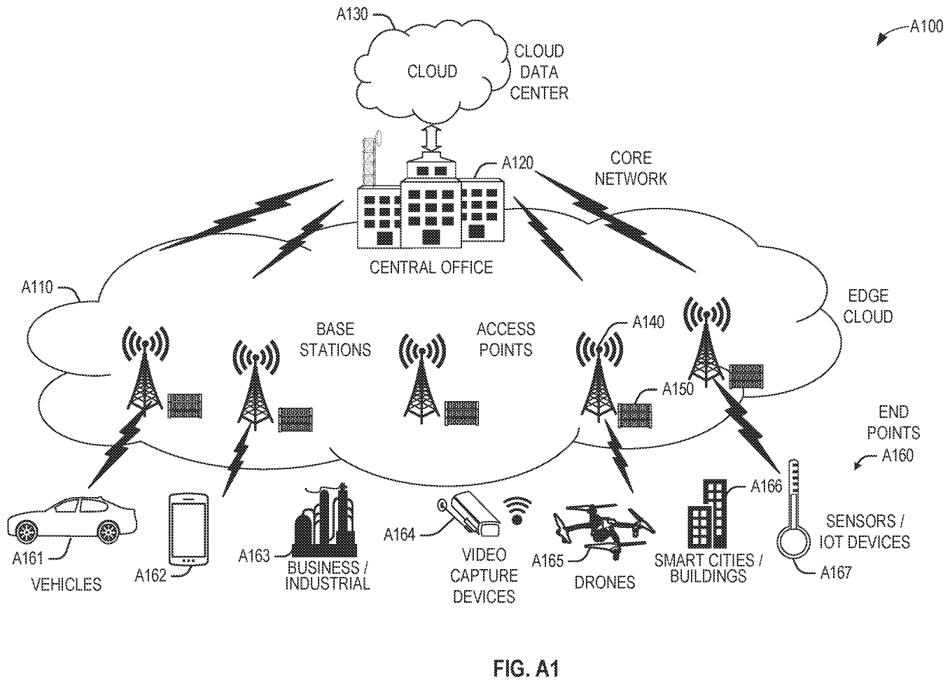

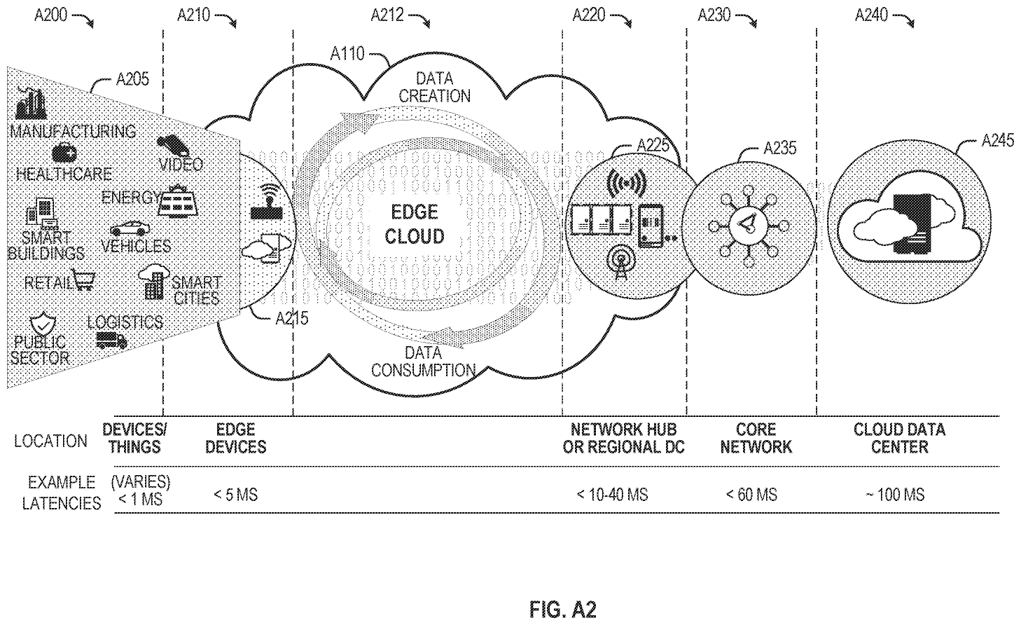

FIG. 1 is a schematic illustration of an example task management system 100 to orchestrate intermittent surplus power in Edge networks. In the illustrated example of FIG. 1, the task management system 100 includes an example platform 102 (e.g. an Edge node) connected to an example renewable energy infrastructure 104 and an example battery subsystem 106. The example renewable energy infrastructure 104 provides power from any type of renewable energy source including, but not limited to solar power sources (e.g., solar cells), wind power sources (e.g., wind turbines), hydro-based power sources, geo-thermal power sources, etc. In some examples, the renewable energy infrastructure 104 includes sensors to retrieve data corresponding to ambient conditions. For instance, rain sensors may detect the presence of rain occurring, lightening sensors may detect the presence of storms within a particular radius (e.g., occurrence of a lightening strike within 10 miles), and cameras may detect the presence of clouds. The example battery subsystem 106 provides power from any number of batteries, which may be located in proximity to the example platform 102 (e.g., in a cabinet, a rack), and/or may be located on the example platform 102 itself.

The example platform 102 includes resources 108, which may include, but are not limited to high-bandwidth memory 110, double data rate (DDR) memory 112 (e.g., DDR synchronous dynamic random-access memory (DDR SDRAM), central processing unit(s) (CPUs) 114 having any number of cores, and accelerators 116 (e.g., neural network accelerators, and signal processors, convolutional neural network processors, etc.). The example platform 102 also includes example adaptive power managing circuitry 118, which includes example power unit analysis circuitry 120, service level agreement (SLA) analysis circuitry 122, analysis circuitry 124, and advertising circuitry 126.

In operation, the example adaptive power managing circuitry 118 performs an inventory of its own resources 108. Generally speaking, the example platform 102 represents one Edge node in a network of any number of communicatively connected Edge nodes. The various Edge nodes may each have different configurations, structures and/or capabilities, such as CPUs 114 having different numbers of cores, more or less memory, etc. As such, the example adaptive power managing circuitry 118 performs the inventory of the example resources 108 so that future advertising of its capabilities can facilitate workload offloading of one or more other networked Edge nodes that might need help, as described in further detail below.

The example power unit analysis circuitry 120 calculates a power unit status of the platform 102 to determine its current power availability. Several conditions and/or factors, if present, may affect the current power availability of the platform 102 including, but not limited to a capacity of the example battery subsystem 106, a current workload demand of the platform 102, circumstances where the example renewable energy infrastructure 104 has experienced disruptions (e.g., cloud cover that prevents solar power harvesting, lack of wind, etc.), thereby causing an excess drain on the example battery subsystem 106, etc. The example SLA analysis circuitry 122 analyzes a current SLA status of the example platform 102 to determine a metric corresponding to the platform's ability to satisfy an agreed-upon SLA for any given workload. Metrics corresponding to the SLA status include, but are not limited to a binary satisfied/not-satisfied metric, or a percentage value (e.g., a threshold value) indicative of a relative progress of the platform 102 to satisfy the SLA obligations (e.g., 90% complete). In some circumstances, unforeseen conditions may strain an ability of the platform 102 to satisfy the SLA, thereby causing an excess drain on battery reserves. If such conditions persist for too long, the platform 102 may need to adjust one or more parameters (“knobs”) in an effort to extend capabilities of the example resources 108, even if such capabilities are diminished (e.g., lowering a processor clock cycle, lowering NIC bandwidth).

In view of the aforementioned resources 108, power unit status and SLA status, the example power unit analysis circuitry 120 determines whether the example platform 102 has a surplus amount of power. If not, the example adaptive power managing circuitry 118 calculates a number of power units that, if processed by a donor platform, would allow the example platform 102 to successfully maintain its SLA obligations, as described in further detail below. On the other hand, in the event the example adaptive power managing circuitry 118 determines that surplus power units are available, then the example adaptive power managing circuitry 118 advertises a quantity of power units that are available for one or more other Edge nodes (e.g., other network connected platforms) to use, as described in further detail below.

Returning to the scenario in which the example platform 102 has a surplus of power units (e.g., based on a combination of 100% battery capacity, full sunlight on a solar array, and an SLA metric indicative of 90% complete with SLA requirements), the example analysis circuitry 124 selects a threshold acceleration factor to apply to one or more tasks (e.g., one or more local tasks that are either currently executing (e.g., on local resources) or scheduled for future execution when one or more triggers occur). In some examples, a local task of interest is not yet executing but has a corresponding metric to identify when the task should trigger/execute. As discussed above, an example normal trigger threshold prior to invoking a defragmentation task could be a 70% defragmentation level of memory. However, when a surplus of power units is available to the example platform 102, the example threshold analysis circuitry 124 applies the acceleration factor to reduce the trigger threshold to accelerate instantiation of the (e.g., local) task before it would otherwise occur under normal circumstances. In other words, application of the acceleration factor to a first trigger threshold generates a second trigger threshold that, when satisfied by current conditions, designates the task for early execution. For example, if the threshold acceleration factor is set to 50%, then the example analysis circuitry 124 adjusts the normal trigger threshold from 70% (e.g., a first trigger threshold) to 35% (e.g., a second or otherwise accelerated trigger threshold). In some examples, speculatively executing one or more tasks in view of surplus power units occurs in a manner that consumes all such surplus power units without remaining power units to share with neighboring Edge nodes (e.g., neighboring platforms). For instance, the speculative execution may occur in the late afternoon while the sun is going down and, upon completion of the speculative tasks, the battery reserves are still full. In some examples, speculatively executing one or more tasks in view of surplus power units occurs in a manner that leaves additional surplus that is capable of being shared with participating Edge nodes.

In the event the example power unit analysis circuitry 120 determines that surplus power units remain and/or in the event the example analysis circuitry 124 determines that there are no candidate workloads/tasks (e.g., local tasks) that can be accelerated, the example advertising circuitry 126 advertises the surplus power units (e.g., to remote Edge nodes having one or more remote tasks capable of being transferred to the example platform 102). In some examples, the advertising circuitry 126 generates telemetry information corresponding to current Edge node capabilities of the local Edge node 102 that can be used by one or more remote Edge nodes communicatively connected to the Edge node 102. In some examples, the advertising circuitry 126 processes any type of telemetry information to/from the platform 102 in which the advertising information (telemetry) includes resources information (e.g., the type and quantity of processors, the type and quantity of accelerators, the type and quantity of memory, the amount of available power units, one or more process address space identifiers (PASIDs) corresponding to candidate tasks to be offloaded, etc.). Example telemetry information 130 is shown in FIG. 1 as a non-limiting example. Stated differently, the advertising circuitry 126 provides “hooks” for power unit surplus discovery.

The example SLA analysis circuitry 122 evaluates a candidate workload (received workload, also referred to as a remote task) that is responsive to the telemetry advertisement to determine that a corresponding SLA can be satisfied by the resources of the Edge node donating the power units (e.g., the “donor Edge node”). In some examples, the SLA analysis circuitry 122 evaluates (a) the PASID corresponding to the workload, (b) information corresponding to criticality of the resources (e.g., core processor type/capability, necessary amount of memory, necessary amount of bandwidth, etc.), and/or (c) conditions to be met by the SLA (e.g., SLA parameters indicative of performance requirements, such as 100 minutes per day of task execution (e.g., garbage collection)). If the example platform 102 and/or its resources 108 are capable of satisfying the SLA parameters corresponding to the remote task, then the example SLA analysis circuitry 122 accepts the remote task for execution, thereby utilizing excess power units that would otherwise be wasted by the renewable energy infrastructure 104. The example adaptive power managing circuitry 118 allocates needed resources to process the received workload, and the SLA analysis circuitry 122 continues to monitor the platform 102 to verify that (a) SLA obligation of the platform workload(s) is satisfied and (b) SLA obligation of the received workload(s) is satisfied. In the event SLA metrics indicate that the SLA obligations cannot be met, the SLA analysis circuitry 122 invokes one or more knobs to adjust performance of the resources 108. For example, in response to decreasing and/or otherwise degradation of SLA metrics, the SLA analysis circuitry 122 increases processor frequency, activates one or more cores, increases I/O bandwidth, etc. when a requisite quantity of power units are available. However, in response to decreasing and/or otherwise degrading SLA metrics, the SLA analysis circuitry 122 may invoke the example advertising circuitry 126 to report back to the Edge node that requested assistance to inform it that the workload(s) cannot be completed in accordance with SLA requirements. When the workload(s) are complete or returned to sender, the example power unit analysis circuitry 120 re-evaluates current conditions to determine if the platform 102 is capable of again helping one or more other platforms with workload execution in view of surplus power unit conditions.

However, in the event the example power unit analysis circuitry 120 determines the platform 102 is experiencing a power deficit, it calculates a quantity of that deficit and invokes the advertising circuitry 126 to query other platforms (Edge nodes) for candidate donors. As described above, any type of telemetry information may be included in the solicitation for candidate donor platforms that can receive one or more workloads in an effort to take advantage of surplus power units that, if not used, would otherwise be wasted.

As described above, FIG. 1 is a schematic illustration of the example task management system 100 to orchestrate intermittent surplus power in Edge networks. The example adaptive power managing circuitry 118 of FIG. 1 may be instantiated (e.g., creating an instance of, bring into being for any length of time, materialize, implement, etc.) by processor circuitry such as a central processing unit executing instructions. Additionally or alternatively, the example adaptive power managing circuitry 118 of FIG. 1 may be instantiated (e.g., creating an instance of, bring into being for any length of time, materialize, implement, etc.) by an ASIC or an FPGA structured to perform operations corresponding to the instructions. Thus, some or all of the circuitry of FIG. 1 may instantiate at the same or different times. Some or all of the circuitry may be instantiated, for example, in one or more threads executing concurrently on hardware and/or in series on hardware. Moreover, in some examples, some or all of the circuitry of FIG. 1 may be implemented by one or more virtual machines and/or containers executing on the microprocessor.

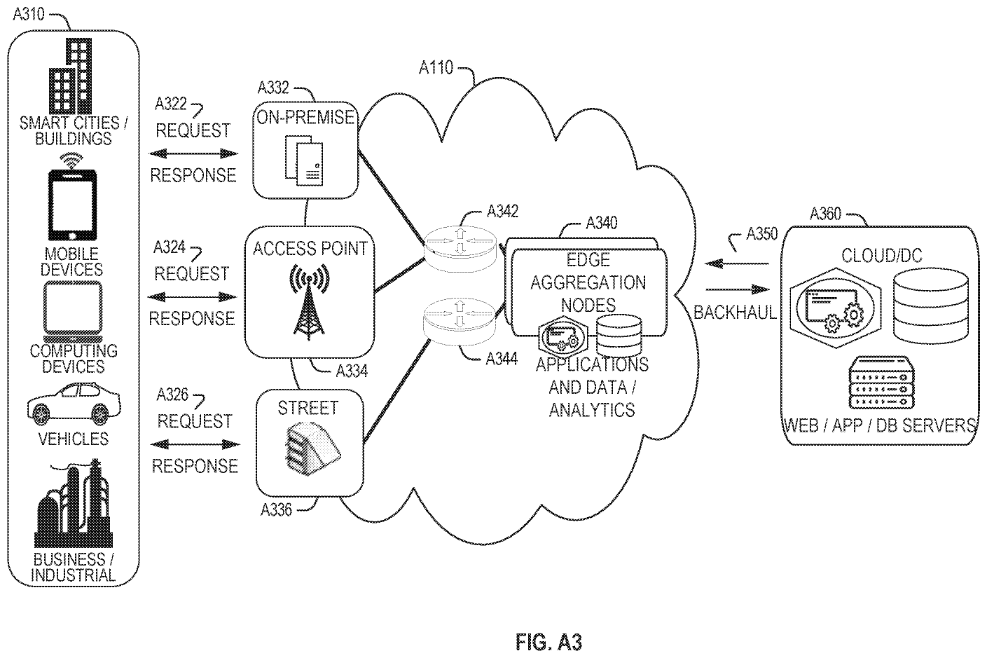

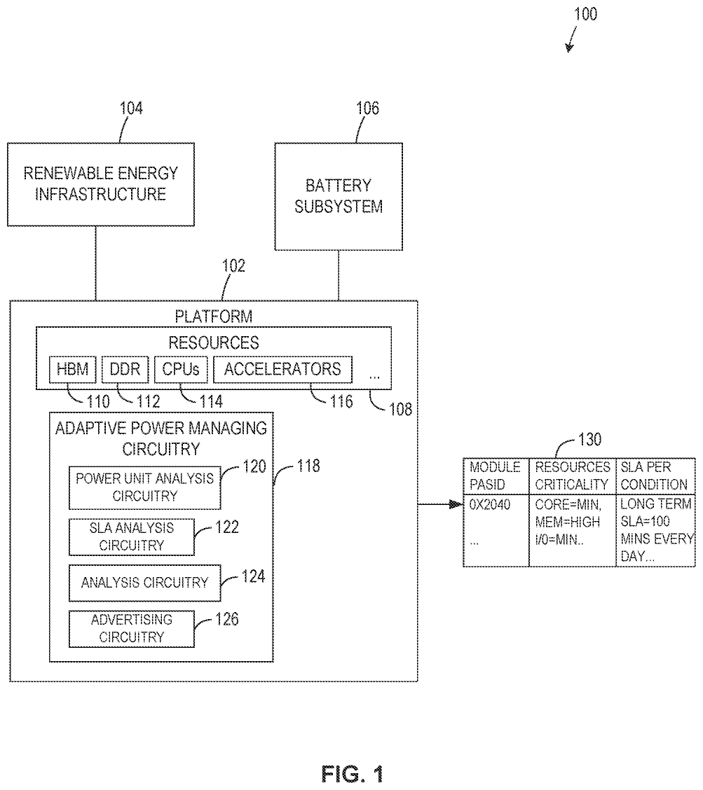

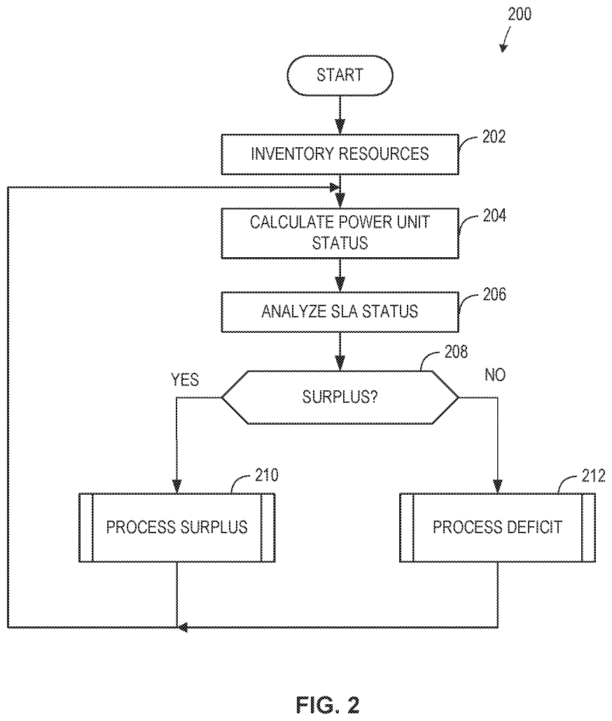

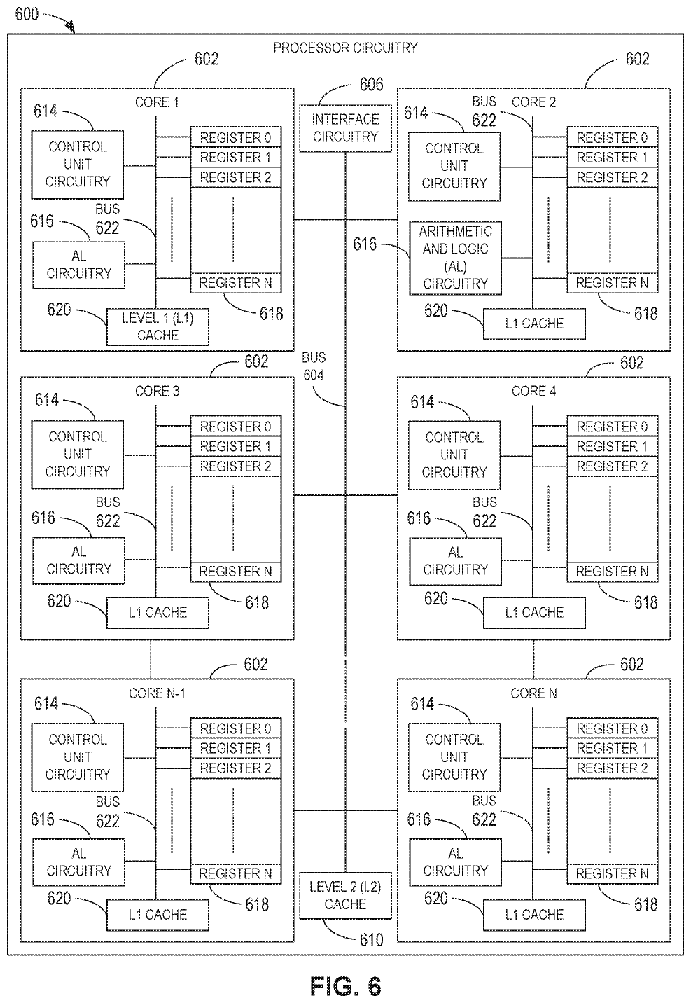

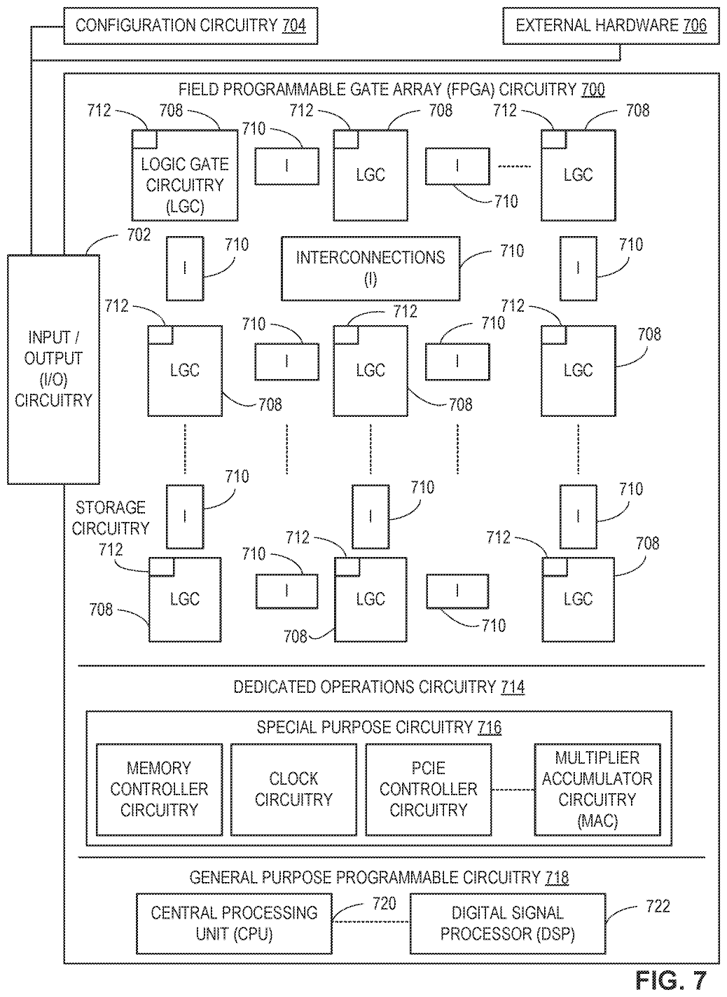

In some examples, the example task management system 100 includes adaptive power managing circuitry 118, which includes means for adaptively managing power. The example power unit analysis circuitry 120 includes means for analyzing power units. The example SLA analysis circuitry 122 includes means for analyzing SLAs. The example analysis circuitry 124 includes means for analyzing thresholds. The example advertising circuitry 126 includes means for advertising. For example, the means for adaptively managing power may be implemented by the example adaptive power managing circuitry 118. The means for analyzing power units may be implemented by the example power unit analysis circuitry 120. The means for analyzing SLAs may be implemented by the example SLA analysis circuitry 122. The means for analyzing thresholds may be implemented by the example analysis circuitry 124. The means for advertising may be implemented by the example advertising circuitry 126. In some examples, the aforementioned circuitry may be instantiated by processor circuitry such as the example processor circuitry 512 of FIG. 5. For instance, the aforementioned circuitry of FIG. 1 may be instantiated by the example general purpose processor circuitry 600 of FIG. 6 executing machine executable instructions such as that implemented by at least blocks of FIGS. 2-4. In some examples, the aforementioned circuitry of FIG. 1 may be instantiated by hardware logic circuitry, which may be implemented by an ASIC or the FPGA circuitry 700 of FIG. 7 structured to perform operations corresponding to the machine readable instructions. Additionally or alternatively, the aforementioned circuitry of FIG. 1 may be instantiated by any other combination of hardware, software, and/or firmware. For example, the aforementioned circuitry of FIG. 1 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example task management system 100 of FIG. 1 is illustrated in FIG. 1, one or more of the elements, processes, and/or devices illustrated in FIG. 1 may be combined, divided, re-arranged, omitted, eliminated, and/or implemented in any other way. Further, the example power unit analysis circuitry 120, the example SLA analysis circuitry 122, the example analysis circuitry 124, the example advertising circuitry 126 and/or, more generally, the example adaptive power managing circuitry 118 of FIG. 1, may be implemented by hardware alone or by hardware in combination with software and/or firmware. Thus, for example, any of the example power unit analysis circuitry 120, the example SLA analysis circuitry 122, the example analysis circuitry 124, the example advertising circuitry 126 and/or, more generally, the example adaptive power managing circuitry 118 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example adaptive power managing circuitry 118 of FIG. 1 may include one or more elements, processes, and/or devices in addition to, or instead of, those illustrated in FIG. 2-4, and/or may include more than one of any or all of the illustrated elements, processes and devices.

Flowcharts representative of example hardware logic circuitry, machine readable instructions, hardware implemented state machines, and/or any combination thereof for implementing the example adaptive power managing circuitry 118 of FIG. 1 are shown in FIGS. 2-4. The machine readable instructions may be one or more executable programs or portion(s) of an executable program for execution by processor circuitry, such as the processor circuitry 512 shown in the example processor platform 500 discussed below in connection with FIG. 5 and/or the example processor circuitry discussed below in connection with FIGS. 6 and/or 7. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 2-4, many other methods of implementing the example adaptive power managing circuitry 118 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 2 is a flowchart representative of example machine readable instructions and/or example operations 200 that may be executed and/or instantiated by processor circuitry to orchestrate intermittent surplus power in Edge networks. The machine readable instructions and/or the operations 200 of FIG. 2 begin at block 202, at which the example adaptive power managing circuitry 118 performs an inventory of resources. As described above, example resources 108 of FIG. 1 may include, but are not limited to the example high bandwidth memory 110, DDR memory 112, CPUs 114, accelerators 116, sensors, actuators, cameras, etc. The example power unit analysis circuitry 120 calculates a current power unit status of the example platform 102 (block 204), which includes capabilities of the example renewable energy infrastructure 104 and/or the example battery subsystem 106. In some examples, the power unit analysis circuitry measures and reports a current energy metric corresponding to the battery subsystem 106, a current energy metric corresponding to the renewable energy infrastructure 104 and/or a current energy draw by the example platform 102.

While the example battery subsystem 106, renewable energy infrastructure 104 and/or the energy draw by the platform 102 may be in any type of energy measurement unit, the example power unit analysis circuitry 120 converts such disparate energy measurement units into a normalized metric of “power unit” to allow relative comparisons between the platforms (e.g., Edge nodes) participating in any network. As such, in the event a first Edge node identifies a surplus of 100 power units, a second Edge node can calculate a corresponding power deficiency using the same metric of power units to determine which one or more donor nodes are capable of assisting the second Edge node.

The example SLA analysis circuitry 122 analyzes a current SLA status of the example platform 102 to determine a metric corresponding to the platform's ability to satisfy an agreed-upon SLA for any given workload (block 206). In particular, based on (a) the current power unit status and (b) whether SLA obligations are being satisfied, the example power unit analysis circuitry 120 determines whether a surplus of power units exists (block 208). In the event of a power surplus, the example adaptive power managing circuitry 118 processes the power surplus to determine how to best utilize the surplus power units that, if not used, would otherwise be wasted (block 210), as described above and in further detail below. On the other hand, in the event of a power unit deficit (e.g., the workload is using a greater quantity of power units than the renewable energy infrastructure 104 and the battery subsystem 106 is expected to handle to satisfy the SLA requirements), then the example adaptive power managing circuitry 118 processes the power deficiency to seek donor Edge nodes to handle workload tasks (block 212).

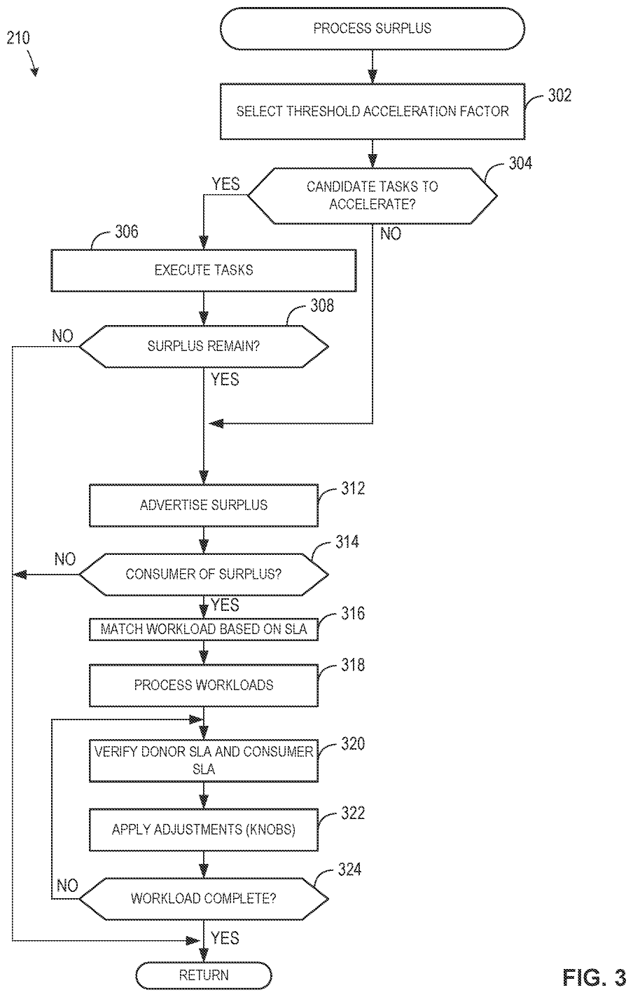

FIG. 3 illustrates additional detail corresponding to processing surplus power units of block 210. In the illustrated example of FIG. 3, the analysis circuitry 124 selects a threshold acceleration factor (block 302) in an effort to identify one or more tasks/workloads that the example platform 102 is expected to complete. As described above, the one or more tasks/workloads may have corresponding trigger thresholds that, when satisfied, cause the platform 102 to execute such tasks/workloads (e.g., a threshold amount of memory defragmentation must be detected prior to initiating a defragmentation task). In some examples, the threshold acceleration factor is selected from memory or provided as an input from a user (e.g., via one or more user interfaces). In some examples, the threshold acceleration factor is a fractional value between zero (0.00) (indicative of a desire not to accelerate one or more tasks) and one (1.00) (indicative of a desire to accelerate the operation of all tasks that have a corresponding threshold trigger value).

In response to the example analysis circuitry 124 applying the acceleration factor to all tasks that have a corresponding trigger threshold value (block 302), the analysis circuitry 124 determines whether there are one or more candidate tasks to accelerate (e.g., one or more tasks to cause to be executed despite their normal threshold trigger value has not yet been satisfied) (block 304). For example, if a first task has a trigger threshold of 70% (e.g., 70% defragmentation must be detected prior to the trigger occurring), and if the acceleration factor is 0.20, and the current defragmentation value (e.g., of memory) is at 30%, then the applied acceleration factor will have no effect on causing the defragmentation task to trigger (i.e., applying the factor of 0.2 to 70% brings the new trigger threshold down to 56%, which is still not “tripped” by the current defragmentation value of 30%). In such a circumstance, control of the example program 210 advances to block 312 to advertise the surplus, as described above and in further detail below.

In response to identifying tasks that become triggered in response to application of the acceleration factor (block 304), the example adaptive power managing circuitry 118 executes the identified tasks/workload(s) (block 306). To ensure that the accelerated task execution has not resulted in a circumstance where the platform 102 no longer has a surplus of power units (e.g., they were all consumed in response to accelerating tasks corresponding to the platform 102), the example power unit analysis circuitry 120 determines whether any surplus power units remain (block 308). If so, the example advertising circuitry 126 advertises the surplus to any number of other Edge nodes that are communicatively connected thereto (block 312). If the example advertising circuitry 126 identifies at least one consumer that responds to the advertised telemetry data corresponding to surplus power units (block 314) (e.g., a candidate workload is received by one or more other Edge nodes), the example SLA analysis circuitry 122 matches the received workload/task to appropriate resources 108 (block 316). As described above, matching the workload to resources may be aided by example telemetry data, such as the example telemetry information 130 shown in the illustrated example of FIG. 1.

The example adaptive power managing circuitry 118 processes the received workloads/tasks (block 318) provided by the one or more other Edge nodes that responded to the advertisement of surplus power units, and the example SLA analysis circuitry 122 verifies that SLA requirements of the example platform 102 that is donating power units and the SLA requirements corresponding to the received workloads are satisfied (block 320). As described above, while the example platform 102 may have surplus power units at a first time and accept any requests to assist processing workload(s) from other Edge nodes, dynamic conditions may occur that reduce the ability of the platform 102 to satisfy SLA requirements. In the event SLA degradation is detected by the example SLA analysis circuitry 122 (block 320), it applies one or more adjustments to preserve at least one of (a) SLA requirement satisfaction (e.g., increasing a quantity and/or type of resources 108 to be applied to the tasks, increasing a frequency of processors executing the tasks), or (b) an ability for the platform 102 to continue operation without sacrificing its own battery reserves (block 322). If the adaptive power managing circuitry 118 determines that the workload is not yet complete (block 324), then control returns to block 320 to verify SLA conditions, otherwise control returns to block 204 of FIG. 2.

Returning to the illustrated example of FIG. 2, if the example power unit analysis circuitry 120 determines that a power unit deficit is occurring (e.g., the workload is using a greater quantity of power units than the renewable energy infrastructure 104 and/or the battery subsystem 106 can provide), then the example adaptive power managing circuitry 118 seeks donor Edge nodes to handle workload tasks (block 212).

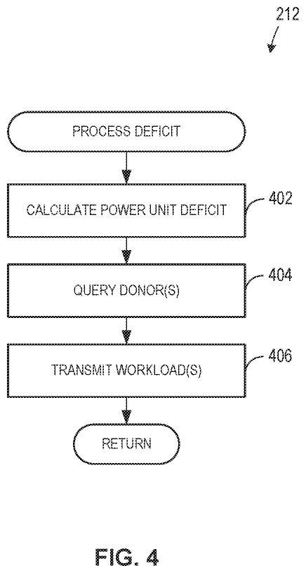

FIG. 4 illustrates additional detail corresponding to processing deficits (block 212 of FIG. 2). In the illustrated example of FIG. 4, the example power unit analysis circuitry 120 calculates a value corresponding to the power unit deficit in common units that all Edge nodes can relate to. In other words, the power unit analysis circuitry 120 calculates the deficiency metric in units of power units, which may initially be based on a number of tasks needed for completion, a number of expected processor cycles corresponding to the one or more processing resources (e.g., processors in the example resources 108), and a particular value of energy per processor cycle unique to the requesting Edge node with the power deficiency (block 402). The example advertising circuitry 126 queries candidate donor Edge nodes that have at least the requisite quantity of surplus power units to be eligible for accepting one or more workloads (block 404). In the event a candidate Edge node includes at least the quantity of power units needed to satisfy the deficiency, the example advertising circuitry 126 transmits the workload(s) to the donating Edge node (block 406). Control then returns to block 204 of FIG. 2.

FIG. 5 is a block diagram of an example processor platform 500 structured to execute and/or instantiate the machine readable instructions and/or the operations of FIGS. 2-4 to implement the platform 102 and/or the corresponding adaptive power managing circuitry 118 of FIG. 1. The processor platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, a headset (e.g., an augmented reality (AR) headset, a virtual reality (VR) headset, etc.) or other wearable device, a network interface card (NIC) (e.g., a smart NIC) or any other type of computing device.

The processor platform 500 of the illustrated example includes processor circuitry 512. The processor circuitry 512 of the illustrated example is hardware. For example, the processor circuitry 512 can be implemented by one or more integrated circuits, logic circuits, FPGAs, microprocessors, CPUs, GPUs, DSPs, and/or microcontrollers from any desired family or manufacturer. The processor circuitry 512 may be implemented by one or more semiconductor based (e.g., silicon based) devices. In this example, the processor circuitry 512 implements the example power unit analysis circuitry 120, the example SLA analysis circuitry 122, the example analysis circuitry 124, the example advertising circuitry 126 and/or the example adaptive power managing circuitry 118.

The processor circuitry 512 of the illustrated example includes a local memory 513 (e.g., a cache, registers, etc.). The processor circuitry 512 of the illustrated example is in communication with a main memory including a volatile memory 514 and a non-volatile memory 516 by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517.

The processor platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user to enter data and/or commands into the processor circuitry 512. The input device(s) 522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 500 of the illustrated example also includes one or more mass storage devices 528 to store software and/or data. Examples of such mass storage devices 528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 532, which may be implemented by the machine readable instructions of FIGS. 2-4, may be stored in the mass storage device 528, in the volatile memory 514, in the non-volatile memory 516, and/or on a removable non-transitory computer readable storage medium such as a CD or DVD.

FIG. 6 is a block diagram of an example implementation of the processor circuitry 512 of FIG. 5. In this example, the processor circuitry 512 of FIG. 5 is implemented by a general purpose microprocessor 600. The general purpose microprocessor circuitry 600 executes some or all of the machine readable instructions of the flowcharts of FIGS. 2-4 to effectively instantiate the circuitry of FIG. 1 as logic circuits to perform the operations corresponding to those machine readable instructions. In some such examples, the circuitry of FIG. 1 is instantiated by the hardware circuits of the microprocessor in combination with the instructions. For example, the microprocessor 600 may implement multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 2-4.

The cores 602 may communicate by a first example bus 604. In some examples, the first bus 604 may implement a communication bus to effectuate communication associated with one(s) of the cores 602. For example, the first bus 604 may implement at least one of an Inter-Integrated Circuit (I2C) bus, a Serial Peripheral Interface (SPI) bus, a PCI bus, or a PCIe bus. Additionally or alternatively, the first bus 604 may implement any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2_cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the L1 cache 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating point operations. In yet other examples, the AL circuitry 616 may include first AL circuitry that performs integer based operations and second AL circuitry that performs floating point operations. In some examples, the AL circuitry 616 may be referred to as an Arithmetic Logic Unit (ALU). The registers 618 are semiconductor-based structures to store data and/or instructions such as results of one or more of the operations performed by the AL circuitry 616 of the corresponding core 602. For example, the registers 618 may include vector register(s), SIMD register(s), general purpose register(s), flag register(s), segment register(s), machine specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure including distributed throughout the core 602 to shorten access time. The second bus 622 may implement at least one of an I2C bus, a SPI bus, a PCI bus, or a PCIe bus

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 7 is a block diagram of another example implementation of the processor circuitry 512 of FIG. 5. In this example, the processor circuitry 512 is implemented by FPGA circuitry 700. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the machine readable instructions in hardware and, thus, can often execute the operations faster than they could be performed by a general purpose microprocessor executing the corresponding software.

More specifically, in contrast to the microprocessor 600 of FIG. 6 described above (which is a general purpose device that may be programmed to execute some or all of the machine readable instructions represented by the flowcharts of FIGS. 2-4 but whose interconnections and logic circuitry are fixed once fabricated), the FPGA circuitry 700 of the example of FIG. 7 includes interconnections and logic circuitry that may be configured and/or interconnected in different ways after fabrication to instantiate, for example, some or all of the machine readable instructions represented by the flowcharts of FIGS. 2-4. In particular, the FPGA 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the software represented by the flowcharts of FIGS. 2-4. As such, the FPGA circuitry 700 may be structured to effectively instantiate some or all of the machine readable instructions of the flowcharts of FIGS. 2-4 as dedicated logic circuits to perform the operations corresponding to those software instructions in a dedicated manner analogous to an ASIC. Therefore, the FPGA circuitry 700 may perform the operations corresponding to the some or all of the machine readable instructions of FIGS. 2-4 faster than the general purpose microprocessor can execute the same.

In the example of FIG. 7, the FPGA circuitry 700 is structured to be programmed (and/or reprogrammed one or more times) by an end user by a hardware description language (HDL) such as Verilog. The FPGA circuitry 700 of FIG. 7, includes example input/output (I/O) circuitry 702 to obtain and/or output data to/from example configuration circuitry 704 and/or external hardware (e.g., external hardware circuitry) 706. For example, the configuration circuitry 704 may implement interface circuitry that may obtain machine readable instructions to configure the FPGA circuitry 700, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 706 may implement the microprocessor 600 of FIG. 6. The FPGA circuitry 700 also includes an array of example logic gate circuitry 708, a plurality of example configurable interconnections 710, and example storage circuitry 712. The logic gate circuitry 708 and interconnections 710 are configurable to instantiate one or more operations that may correspond to at least some of the machine readable instructions of FIGS. 2-4 and/or other desired operations. The logic gate circuitry 708 shown in FIG. 7 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations. The logic gate circuitry 708 may include other electrical structures such as look-up tables (LUTs), registers (e.g., flip-flops or latches), multiplexers, etc.

The interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example Dedicated Operations Circuitry 714. In this example, the Dedicated Operations Circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the processor circuitry 512 of FIG. 5, many other approaches are contemplated. For example, as mentioned above, modem FPGA circuitry may include an on-board CPU, such as one or more of the example CPU 720 of FIG. 7. Therefore, the processor circuitry 512 of FIG. 5 may additionally be implemented by combining the example microprocessor 600 of FIG. 6 and the example FPGA circuitry 700 of FIG. 7. In some such hybrid examples, a first portion of the machine readable instructions represented by the flowcharts of FIGS. 2-4 may be executed by one or more of the cores 602 of FIG. 6, a second portion of the machine readable instructions represented by the flowcharts of FIGS. 2-4 may be executed by the FPGA circuitry 700 of FIG. 7, and/or a third portion of the machine readable instructions represented by the flowcharts of FIGS. 2-4 may be executed by an ASIC. It should be understood that some or all of the circuitry of FIG. 1 may, thus, be instantiated at the same or different times. Some or all of the circuitry may be instantiated, for example, in one or more threads executing concurrently and/or in series. Moreover, in some examples, some or all of the circuitry of FIG. 1 may be implemented within one or more virtual machines and/or containers executing on the microprocessor.

In some examples, the processor circuitry 512 of FIG. 5 may be in one or more packages. For example, the processor circuitry 600 of FIG. 6 and/or the FPGA circuitry 700 of FIG. 7 may be in one or more packages. In some examples, an XPU may be implemented by the processor circuitry 512 of FIG. 5, which may be in one or more packages. For example, the XPU may include a CPU in one package, a DSP in another package, a GPU in yet another package, and an FPGA in still yet another package.

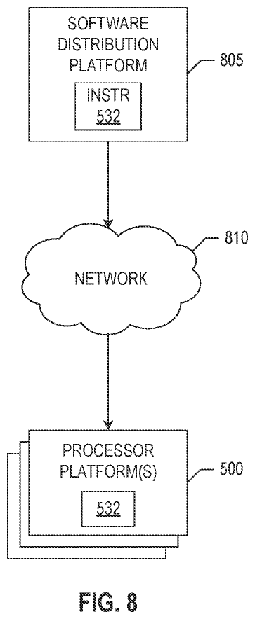

A block diagram illustrating an example software distribution platform 805 to distribute software such as the example machine readable instructions 532 of FIG. 5 to hardware devices owned and/or operated by third parties is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIGS. 2-4, as described above. The one or more servers of the example software distribution platform 805 are in communication with a network 810, which may correspond to any one or more of the Internet and/or any of the example networks described herein. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIGS. 2-4, may be downloaded to the example processor platform 500, which is to execute the machine readable instructions 532 to implement examples disclosed herein. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices.

From the foregoing, it will be appreciated that example systems, methods, apparatus, and articles of manufacture have been disclosed that orchestrate and/or otherwise manage circumstances where Edge network nodes (e.g., platforms) have intermittent surplus power. Disclosed systems, methods, apparatus, and articles of manufacture improve the efficiency of Edge networks by optimizing circumstances where excess power is utilized rather than wasted, particularly in Edge networks that rely on renewable energy sources like solar and wind. Edge nodes normally include any number of tasks that require particular trigger thresholds prior to execution, but examples disclosed herein accelerate such triggers when surplus power is available. In effect, utilization of surplus power to execute tasks earlier than usual results in bolstering an ability for Edge network nodes to be ready for unforeseen emergency task execution where limited on-board battery storage can be maintained in a relatively higher state.

Example methods, apparatus, systems, and articles of manufacture to orchestrate intermittent surplus power in Edge networks are disclosed herein. Further examples and combinations thereof include the following:

Example 1 includes an apparatus to manage surplus power comprising power unit analysis circuitry to identify a power surplus, threshold analysis circuitry to apply an acceleration factor to a first trigger threshold of a local task, the acceleration factor to set a second trigger threshold, and designate the local task for early execution when a current metric corresponding to the local task satisfies the second trigger threshold, and adaptive power managing circuitry to execute the local task in response to detecting the designation for early execution.

Example 2 includes the apparatus as defined in example 1, further including advertising circuitry to advertise the power surplus to remote nodes.

Example 3 includes the apparatus as defined in example 2, wherein the advertising circuitry is to generate telemetry information corresponding to available resources.

Example 4 includes the apparatus as defined in example 3, wherein the telemetry information includes at least one of a type of available processor, a quantity of processor cores, a type of available memory, a quantity of memory, or a type of accelerator.

Example 5 includes the apparatus as defined in example 2, wherein the advertising circuitry is to generate telemetry information corresponding to a quantity associated with the power surplus.

Example 6 includes the apparatus as defined in example 1, further including service level agreement (SLA) analysis circuitry to determine SLA parameters associated with a remote task.

Example 7 includes the apparatus as defined in example 6, wherein the SLA analysis circuitry is to accept the remote task for local execution if local resources satisfy the SLA parameters.

Example 8 includes an apparatus to control surplus power allocation comprising interface circuitry to facilitate network communication, and processor circuitry including one or more of at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations, or the third operations to instantiate power unit analysis circuitry to identify a power surplus, analysis circuitry to apply an acceleration factor to a first trigger threshold of a local task, the acceleration factor to set a second trigger threshold, and designate the local task for early execution when a current metric corresponding to the local task satisfies the second trigger threshold, and adaptive power managing circuitry to execute the local task in response to detecting the designation for early execution.

Example 9 includes the apparatus as defined in example 8, further including advertising circuitry to advertise the power surplus to remote nodes.

Example 10 includes the apparatus as defined in example 9, wherein the advertising circuitry is to generate telemetry information corresponding to available resources.

Example 11 includes the apparatus as defined in example 10, wherein the telemetry information includes at least one of a type of available processor, a quantity of processor cores, a type of available memory, a quantity of memory, or a type of accelerator.

Example 12 includes the apparatus as defined in example 9, wherein the advertising circuitry is to generate telemetry information corresponding to a quantity associated with the power surplus.

Example 13 includes the apparatus as defined in example 8, further including service level agreement (SLA) analysis circuitry to determine SLA parameters associated with a remote task.

Example 14 includes the apparatus as defined in example 13, wherein the SLA analysis circuitry accepts the remote task for local execution if local resources satisfy the SLA parameters.

Example 15 includes a system to direct surplus power in an Edge network comprising means for analyzing power units to identify a power surplus, means for analyzing thresholds to apply an acceleration factor to a first trigger threshold of a local task, the acceleration factor to set a second trigger threshold, and designate the local task for early execution when a current metric corresponding to the local task satisfies the second trigger threshold, and means for adaptively managing power to execute the local task in response to detecting the designation for early execution.

Example 16 includes the system as defined in example 15, further including means for advertising to advertise the power surplus to remote nodes.

Example 17 includes the system as defined in example 16, wherein the means for advertising is to generate telemetry information corresponding to available resources.

Example 18 includes the system as defined in example 17, wherein the telemetry information includes at least one of a type of available processor, a quantity of processor cores, a type of available memory, a quantity of memory, or a type of accelerator.

Example 19 includes the system as defined in example 16, wherein the means for advertising is to generate telemetry information corresponding to a quantity associated with the power surplus.

Example 20 includes the system as defined in example 15, further including means for service level agreement (SLA) analyzing to determine SLA parameters associated with a remote task.

Example 21 includes the system as defined in example 20, wherein the means for SLA analyzing is to accept the remote task for local execution if local resources satisfy the SLA parameters.

Example 22 includes At least one non-transitory computer readable storage medium comprising instructions that, when executed, cause at least one processor to at least identify a power surplus, apply an acceleration factor to a first trigger threshold of a local task, the acceleration factor to set a second trigger threshold, designate the local task for early execution when a current metric corresponding to the local task satisfies the second trigger threshold, and execute the local task in response to detecting the designation for early execution.

Example 23 includes the at least one computer readable storage medium as defined in example 22, wherein the instructions, when executed, cause the at least one processor to advertise the power surplus to remote nodes.

Example 24 includes the at least one computer readable storage medium as defined in example 23, wherein the instructions, when executed, cause the at least one processor to generate telemetry information corresponding to available resources.

Example 25 includes the at least one computer readable storage medium as defined in example 24, wherein the instructions, when executed, cause the at least one processor to identify the telemetry information as at least one of a type of available processor, a quantity of processor cores, a type of available memory, a quantity of memory, or a type of accelerator.

Example 26 includes the at least one computer readable storage medium as defined in example 23, wherein the instructions, when executed, cause the at least one processor to generate telemetry information corresponding to a quantity associated with the power surplus.

Example 27 includes the at least one computer readable storage medium as defined in example 22, wherein the instructions, when executed, cause the at least one processor to determine service level agreement (SLA) parameters associated with a remote task.

Example 28 includes the at least one computer readable storage medium as defined in example 27, wherein the instructions, when executed, cause the at least one processor to accept the remote task for local execution if local resources satisfy the SLA parameters.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to manage surplus power comprising:
power unit analysis circuitry to identify a power surplus;
threshold analysis circuitry to:
apply an acceleration factor to a first trigger threshold of a local task, the acceleration factor to set a second trigger threshold; and
designate the local task for early execution when a current metric corresponding to the local task satisfies the second trigger threshold; and
adaptive power managing circuitry to execute the local task in response to detecting the designation for early execution.

2. The apparatus as defined in claim 1, further including advertising circuitry to advertise the power surplus to remote nodes.

3. The apparatus as defined in claim 2, wherein the advertising circuitry is to generate telemetry information corresponding to available resources.

4. The apparatus as defined in claim 3, wherein the telemetry information includes at least one of a type of available processor, a quantity of processor cores, a type of available memory, a quantity of memory, or a type of accelerator.

5. The apparatus as defined in claim 2, wherein the advertising circuitry is to generate telemetry information corresponding to a quantity associated with the power surplus.

6. The apparatus as defined in claim 1, further including service level agreement (SLA) analysis circuitry to determine SLA parameters associated with a remote task.

7. The apparatus as defined in claim 6, wherein the SLA analysis circuitry is to accept the remote task for local execution if local resources satisfy the SLA parameters.

8. An apparatus to control surplus power allocation comprising:
interface circuitry to facilitate network communication; and
processor circuitry including one or more of:
at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations;
the processor circuitry to perform at least one of the first operations, the second operations, or the third operations to instantiate:
power unit analysis circuitry to identify a power surplus;
analysis circuitry to:
apply an acceleration factor to a first trigger threshold of a local task, the acceleration factor to set a second trigger threshold; and
designate the local task for early execution when a current metric corresponding to the local task satisfies the second trigger threshold; and
adaptive power managing circuitry to execute the local task in response to detecting the designation for early execution.

9. The apparatus as defined in claim 8, further including advertising circuitry to advertise the power surplus to remote nodes.

10. The apparatus as defined in claim 9, wherein the advertising circuitry is to generate telemetry information corresponding to available resources.

11. The apparatus as defined in claim 10, wherein the telemetry information includes at least one of a type of available processor, a quantity of processor cores, a type of available memory, a quantity of memory, or a type of accelerator.

12. The apparatus as defined in claim 9, wherein the advertising circuitry is to generate telemetry information corresponding to a quantity associated with the power surplus.

13. The apparatus as defined in claim 8, further including service level agreement (SLA) analysis circuitry to determine SLA parameters associated with a remote task.

14. The apparatus as defined in claim 13, wherein the SLA analysis circuitry accepts the remote task for local execution if local resources satisfy the SLA parameters.

15. A system to direct surplus power in an Edge network comprising:
means for analyzing power units to identify a power surplus;
means for analyzing thresholds to:
apply an acceleration factor to a first trigger threshold of a local task, the acceleration factor to set a second trigger threshold; and
designate the local task for early execution when a current metric corresponding to the local task satisfies the second trigger threshold; and
means for adaptively managing power to execute the local task in response to detecting the designation for early execution.

16. The system as defined in claim 15, further including means for advertising to advertise the power surplus to remote nodes.

17. The system as defined in claim 16, wherein the means for advertising is to generate telemetry information corresponding to available resources.

18. The system as defined in claim 17, wherein the telemetry information includes at least one of a type of available processor, a quantity of processor cores, a type of available memory, a quantity of memory, or a type of accelerator.

19. The system as defined in claim 16, wherein the means for advertising is to generate telemetry information corresponding to a quantity associated with the power surplus.

20. The system as defined in claim 15, further including means for service level agreement (SLA) analyzing to determine SLA parameters associated with a remote task.

21. The system as defined in claim 20, wherein the means for SLA analyzing is to accept the remote task for local execution if local resources satisfy the SLA parameters.

22. At least one non-transitory computer readable storage medium comprising instructions that, when executed, cause at least one processor to at least:
identify a power surplus;
apply an acceleration factor to a first trigger threshold of a local task, the acceleration factor to set a second trigger threshold;
designate the local task for early execution when a current metric corresponding to the local task satisfies the second trigger threshold; and
execute the local task in response to detecting the designation for early execution.

23. The at least one computer readable storage medium as defined in claim 22, wherein the instructions, when executed, cause the at least one processor to advertise the power surplus to remote nodes.

24. The at least one computer readable storage medium as defined in claim 23, wherein the instructions, when executed, cause the at least one processor to generate telemetry information corresponding to available resources.

25. The at least one computer readable storage medium as defined in claim 24, wherein the instructions, when executed, cause the at least one processor to identify the telemetry information as at least one of a type of available processor, a quantity of processor cores, a type of available memory, a quantity of memory, or a type of accelerator.

26-28. (canceled)
